(19) United States
(12) Patent Application Publication
(10) Pub. No.: US 2008/0221750 A1
(43) Pub. Date: Sep. 11, 2008

(54) METHODS, APPARATUS, AND COMPUTER MEDIA AND SIGNALS FOR REDUCING GHG BY IMPOSING RESTRICTIONS ON EXCESSIVE USAGES OF VEHICLES AND OTHER AIR, SEA, AND ENVIRONMENT POLLUTING MACHINERY AND EQUIPMENTS

(76) Inventor: Mohammad Reza Baraty, (US)

Correspondence Address: M. Reza Baraty, 1081 Ayshire Drive, Burnaby, B.C, V5A 3Z9, omitted

(21) Appl. No.: 11/943,960

(22) Filed: Nov. 21, 2007

Related U.S. Application Data
(60) Provisional application No. 60/905,074, filed on Mar. 6, 2007.

(51) Int. Cl. G01M 17/00

(52) U.S. Cl. 701/33; 701/29

(57) ABSTRACT

Methods, apparatus, media and signals for automatically and smartly monitoring, controlling, and restricting excessive usage of: mechanically, and/or electrically, and/or electro-mechanically, and/or chemically propelled: land, sea, and air/space transportation systems in order to reduce energy consumption and to reduce release of CO2 and other pollutant into the air, soil, and water and to enforce the Kyoto or other international, or nationally allocated pollution quota for operators of transportation means are disclosed. Generally each involves receiving and storing a representation of operation of a Machine, receiving and storing representation of an operator in a control system, and producing a control signal for use by a control apparatus, or a remote authority, if values represented in operation of a Machine are outside of corresponding allowed values of the representation of an operator.

### PRIORITY CLAIM

THE PRESENT APPLICATION CLAIMS PRIORITY FROM U.S. PROVISIONAL PATENT APPLICATION NUMBER: US60/905,074 FILED ON MARCH 06, 2007 AND FOREIGN FILING LICENSE GRANTED ON Mar. 22, 2007.

THIS INVENTION IS DIRECTED TO THE: METHODS, APPARATUS, AND COMPUTER MEDIA AND SIGNALS FOR REDUCING GHG BY IMPOSING RESTRICTIONS ON EXCESSIVE USAGES OF VEHICLES AND OTHER AIR, SEA, AND ENVIRONMENT POLLUTING MACHINERY AND EQUIPMENTS.

### BACKGROUND OF THE INVENTION

This application relates to methods, apparatus, media and signals, for automatically and smartly: monitoring, controlling, and restricting excessive usage of vehicles in order to reduce release of CO2 and other pollutant into the air, soil, and water, and in order to comply with Kyoto or other international or national quota.

Global warming which has been long ignored by most of worlds' community from the first scientific evidences put forward by scientists in 1970's, now rapidly expanding and adversely effecting living condition of human, animals and vegetation. Consumption of the Hydrocarbons (fossil fuel, bio-fuel, or fuel cell using natural gas as a source of Hydrogen), in order to obtain thermal or electrical energy, releases unwanted chemical by-products. Most importantly among those is CO2 or Green House Gas which, studies show is the main contributor to global warming and climate change.

Among many contributors to increased level of GHG are: Industrial machinery and farm equipments, sea, air, and land transportation means, power plants, and most importantly private cars. In the United States and Canada and western countries barely we can see more than 2 people in a car. A typical single driver SUV, sedan or compact car with air-conditioning, music, and all times lights on, is what we see in the roads.

Although education is a must but insofar it has not proven to be effective; we need rules and regulation to restrict excessive use or misuse of private vehicles by ignorant users. Same way we educate people not to offend others but at the same time we also enforce rules and regulations to stop wrong doers. We also would need technological solutions for implementing such restrictions on misuse of energy and excessive release of GHG and other pollutants.

### DESCRIPTION OF THE RELATED ARTS

In my previous patents and applications I have shown the methods and taught technological steps to curtail misuse of energies and drinking water by all levels of consumers from household to public, commercial, farm or industrial users.

Canadian application 2577685 teaches methods for removal of Carbon Dioxide from air, Canadian Patent 2025654 teaches method and apparatus for recovering CO2 from exhaust gases, Canadian Patent 2560678 teaches method of trading emission reductions, Canadian application 2507565 teaches system and method for tracking environmental emission reductions, US application 20050056593 teaches filtrating contaminants, and U.S. Pat. No. 6,447,437 teaches reducing CO2, CO, NOx and Sox from combustion facility to fertilizer. These are all positive steps towards protecting the environment, but generally targeting industries and mainly remedying and rectifying effects of mistakes done, and poisons spilled. In contrast I am trying to provide solutions to reduce harm, and halt irresponsibility, misuse, and ignorance in advance.

In Kyoto accord there has been allocated a quota for reduction of CO2 by each participating country, and unfortunately all fingers are pointed in only one source of pollution which is industries including power producers. Until recently governments have been ignorant to impose restrictions to other important polluters i.e. drivers or operators of private/public transportation means mainly because of lack of technological solution that will be introduced in this application. If world's community wants to reach the agreed GHG reduction quota and be responsible and respectful to the future generation then every individual in the society has to take part of the responsibility.

### SUMMARY OF THE INVENTION

The present invention addresses and teaches the above needed methods and technological solutions in two embodiments:

### FIRST EMBODIMENT

In accordance with one aspect of this invention there is provided a method of rationing GHG release among all level of the society, that leads to allowing a quota for releasing GHG to each driver/operator with regards to his/her job activity distance to drive for work, health and age condition, etc.

The method may include recording said quota in an embedded rewritable and readable chip or magnetic strip on persons driving license, or in a wirelessly communicating (Blue Tooth, WI-FI, RF, or similar) portable small and smart chip. Said smart chip may also contain information that standard driving license contains and may serve as electronic license.

In accordance with another aspect of this invention there is provided a method of: installing a computer device in the vehicle including relating wired or wireless electronic interface devices like card reader/scanner and chip reader or keyboard to the said computer, installing relating data storage device to the said computer, installing relating memory device for the said computer, receiving and storing driver's allowed quota through at least one of the said interface devices in the said computer, receiving and storing rate of GHG production of the vehicle per time, speed, and location from car manufacturer or annual checkup mechanics or a measurement device, at the same computer, and producing control signal for use by a control apparatus if driver's allowed quota reached or passed, recording back and updating and storing available quota of the driver on the driver's license or chip while vehicle is on, continuously, or periodically or as soon as it turned off.

The method may include installing control apparatus for disconnecting or adjusting power to starter device of the vehicle or to the fuel supply of the of the vehicle, said control device is responsive to signals received from the said computer and may adjust the power or adjust the fuel flow to various components and mechanisms of the vehicle accordingly.

In accordance with another aspect of the invention there is provided a method of inspecting and retrieving drivers recorded data of GHG release from his license or ID chip periodically by authorities for the purpose of penalizing for over quota, or rewarding for under quota release of GHG. This method includes a computer device capable of reading and retrieving data by scanning or reading wirelessly.

### SECOND EMBODIMENT

In accordance with another aspect of the invention there is provided a method of: monitoring usages of the cars and other transportation means, receiving in real time and recording in a computerized control system in the vehicle a representation of the operator/driver, allotted quota to that specific person for releasing polluting chemicals such as C, CO2, CO, NOx, Sox, etc while operating a vehicle, and creating a direct link between said control system and starter or fuel supply mechanism of any transportation means so that when driver's or operator's allowed pollution level for the given period reached those mechanisms might be disabled and driver or operator won't be able to drive for the rest of the time period of allotment or would be reported to a remote control authority for penalization in accordance with rules and regulations. Extended benefit of this method is recognition and relating the driver and vehicle and communicating the results on real-time and dynamically to concerned authorities. This will immediately identify theft and unauthorized operation and may smartly or remotely disable the vehicle, or if vehicle is on the road or chased by police its speed could be reduced safely to stop. In accordance with another aspect of the invention said computer controlled system in the car, truck, or any land, air, sea transportation means is in direct or indirect communication with a remote computer control system, in the land, sea, air or outer space station.

In accordance with another aspect of the invention there is provided a method to employ Internet, satellite, radio, or any type of communication, and analogue or digital data transmission between the said control system in the vehicle and the said remote, control station.

In accordance with another aspect of the invention there is provided a computer readable medium for providing instruction codes executable by a programmable device for directing the device to receive representation of driver/operator, receive and store total and remaining quota for a period and produce a control signal for use by control apparatus when allotted amount for represented driver/operator reached or passed.

In accordance with another aspect of the invention there is provided a computer data signal embodied in a carrier wave. The computer data signal includes code segments for directing programmable device to receive a representation of the driver/operator, receive and store total and remaining quota for a period and produce a control signal for use by control apparatus when allotted amount for represented driver/operator reached or passed.

In accordance with another aspect of the invention the method may include requesting by vehicles computer a representation of the driver/operator and his/her/its remaining quota by communicating with a remote station, and updating and reporting back updated quota to the said control station

In accordance with another aspect of the invention the driver/operator may be a robot or computerized automatic driving/operating mechanism.

In accordance with another aspect of the invention there is provided an apparatus for monitoring and controlling operation of a vehicle by a specific driver/operator. It may be installed inside or outside the vehicle and includes a communication or interface device operable to receive representation of driver/operator and total and remaining quota for that driver/operator, a data storage device operable to store: the representation of the driver/operator, said remaining quota, and dynamic data relating to operation of the vehicle. Said apparatus may store data relating to quantity and quality of emissions and amount of pollution by the vehicle in specified time, speed, and location as measured in real time or provided by the manufacturer or authorized sources in order to calculate the accumulation or emission of polluting materials during operation session. The apparatus may include a local or remote processor for processing data and calculation of polluting.

The communication device may be operable to receive plurality of limits of polluting for represented plurality of driver/operator, and plurality of quantities and qualities of emissions from the vehicle. Storage device may be operable to store plurality of limits of polluting for plurality of drivers/operators, and plurality of quantities and qualities of emissions for the vehicle.

The communication device may be operable to establish communication with either a server or remote server to request information about driver/operator, and to provide range of information about the vehicle, its polluting specifications, or request such information and transmit it to the control authorities.

In accordance with another aspect of the invention the control apparatus inside the vehicle receive control signal from the computer of the vehicle or remote computer of authorized sources and may take following actions:
a—If allowed to restrict power to the ignition or fuel supply system if vehicle is stationed;
b—To restrict or adjust electric power to fuel supply if vehicle is on the move;
c—To alarm and inform the driver/operator that he/she/it has past the limit of quota by audio, visual or data signals;
d—Smartly or by instruction from operator/driver to adjust the flow of fuel towards optimum or minimum pollution levels; and
e—Turn off or regulate peripherals of the vehicle for example: music, TV, air conditioning, refrigerator etc for the period that allowed quota reached.

In another aspect of the invention there is provided combination of measuring devices to measure different types of emissions from the vehicle and communicate those to vehicles' said computer.

In another aspect of the invention there is provided a computerized remote control station/s which includes: processing device, storage device, and communication device. All transmitted data relating to representation of driver/operator, his/her/its allowed share of polluting per time period, and history of usage of those limits per driving/operating session are stored in said remote station's storage device/s and later released to vehicles' control apparatus, or to the concerned authorities upon request.

### BRIEF DESCRIPTION OF THE DRAWINGS

In drawings which illustrate both embodiments of the invention:

FIG. 1: is the schematic diagram of the method for monitoring and controlling pollution produced by a driver/operator of a vehicle.

FIGS. 2 and 2/1: are schematic diagram of the vehicle's and remote station's computerized control systems.

FIG. 3: is the flow chart depicting a process affected by a processor circuit of the vehicles' control system.

### DETAILED DESCRIPTION

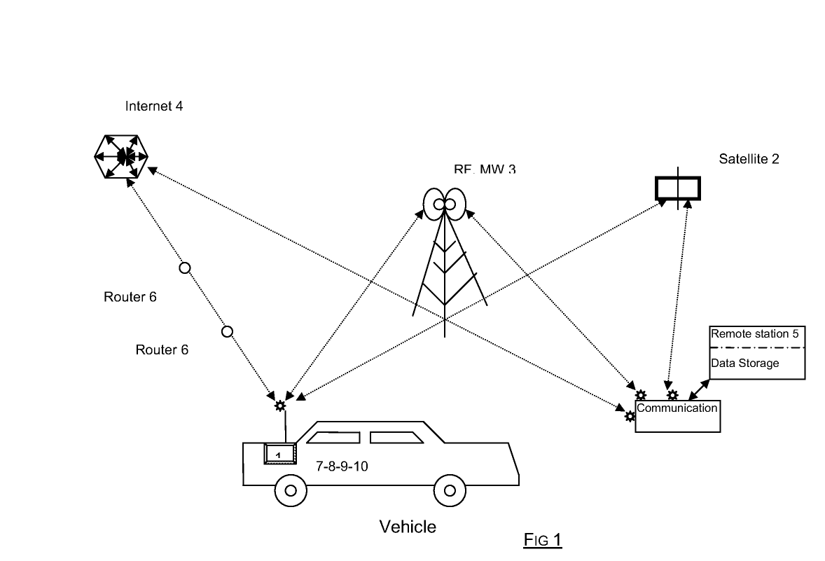

Referring to FIG. 1 a process of controlling polluting quota of a driver/operator disclosed. A computer control device 1 is located inside a vehicle and may have one or all of interface devices 8 (keyboard), 9 (card reader/scanner), 10 (wireless short range communication), and 7 a data storage device. Through interface devices a driver/operator is introduced to the vehicle computer. Vehicle computer may have driver/operators quota in its storage device or may request it from a remote server located at 5 a remote control station. Communication between vehicle computer and remote station computer may employ one or all of 4 (Internet via routers 6), 3 (radio FM, AM, MW etc.), 2 (satellite) communication methods, or any other available methods of transmitting data over wave, laser, wire, light and microwave.

A driver/operator introduces himself/herself/itself via at least one of the interface devices 8, 9, 10 to the computer 1. Computer checks specifications and quota limit with corresponding value at its storage device 7 and finds if driver/operator can operate the vehicle. If computer's storage device lacks information about specific driver/operator then computer communicates with 5 remote control station and requests the quota about that specific driver/operator.

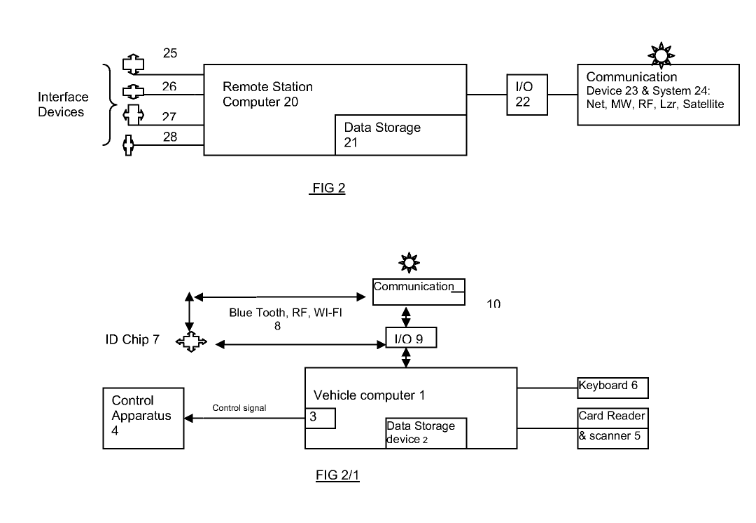

Referring now to FIG. 2/1 schematic diagrams of vehicle and control station computers is disclosed. A vehicle computer system 1 may include 2 (data storage device), 3 (control signal generator), 4 (power or fuel control apparatus), 5 (card reader/scanner), 6 (keyboard), 7 (ID chip reader by short range wireless, similar to 8 (Blue Tooth, WI-FI, RF or other means of networking), 9 (I/O ports), 10 (communication device). A driver/operator who wants to drive or operate the vehicle when comes to proximity of the vehicle a chip reader can read his/her/its specifications to the computer if 7 ID chip was not available driver/operator may use driving license and swipe scan the information through 5 card reader into the computer and if chip reader and card scanner is not available driver/operator might enter few codes by 6 keyboard into the computer 1. After receiving representation of the driver/operator computer searches the data to find latest available quota for that driver/operator and if latest data was not already stored for that driver/operator, computer through its I/O ports 9 and communication device 10 requests such quota from the remote control station/s and stores in its storage device then allows or disallows starter or fuel system. All such process may only take few seconds.

Referring now to the same FIG. 2 schematic diagram of remote computer controlled station is disclosed. A computer system 20 may include 21 (data storage device), interface devices 25, 26, 27, 28 (similar to 5, 6, 7, 8 mentioned in FIG. 2/1), 22 (I/O ports), and 23, 24 (communication device, communication system respectively). The computer 20, receives data request from computer 1 of FIG. 1 via communication devices, verifies it, and may search storage 21 and find the information then release the info via communicating to said computer 1. Computer 20 may receive back updated data from said computers and store it in storage device 21. Computer 20 may receive instructions through its interface devices and send one or more control signal via computer 1 of FIG. 2/1 to 4 (control apparatus) of FIG. 2/1 to affect operation of a vehicle remotely.

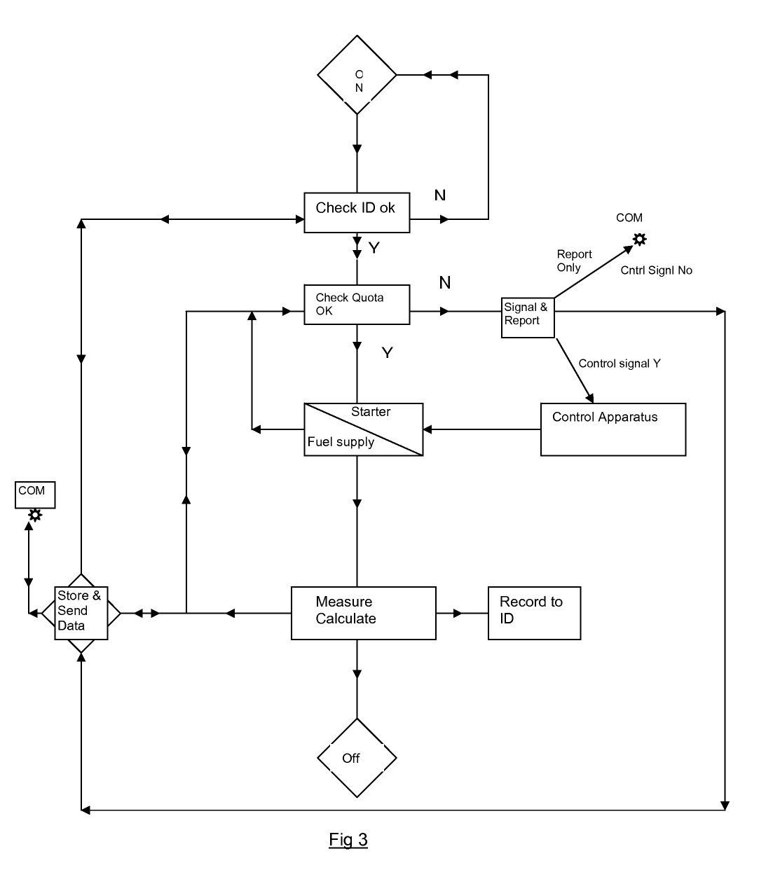

Referring now to FIG. 3 flowchart of operation of a vehicle is shown. When driver/operator scanned his driving license to card reader or entered to the vehicle with ID chip or punched his code in the keyboard process at ON starts, first ID is checked and recorded, then quota is checked, if, quota is ok, starter/fuel pump turns on the vehicle then process of measuring or calculating pollution starts and continuously or periodically transmitted to quota check and data storage device. If quota is not ok then:
1—control signal is sent to control apparatus for action if allowed, or;
2—starter/fuel pump turns on or stays on but report is send to remote control station, stored in the vehicle computer's storage device and written to ID chip and/or driving license.

When vehicle turned off, latest updated quota is written to drivers' license or ID chip and stored in vehicle computer's storage device and communicated to remote station, and then process goes to OFF and ends.

While specific embodiments of the invention have been described and illustrated, such embodiments, illustrations, or examples in descriptions, should be considered illustrative and informative and not limiting the invention as construed with the accompanying claims.

1- A method of controlling through monitoring, and measuring, release or emission of substances to the environment by an operator (Operator) through process of operating a: mechanically, and/or electrically, and/or electro-mechanically, and/or chemically propelled transportation system (Machine), the method comprising:
Providing a control system aboard the Machine, and/or aboard the component or peripheral of the Machine;
Receiving and storing in the said control system a representation of operation of the Machine, said representation comprising a measured value of at least one substance emitted or released to the environment as a result of process of operation of the Machine operated by the Operator, and/or at least one value pertaining to fuel or any other source of energy used to propel the Machine, and/or at least one geographical coordinate of the Machine;
Receiving and storing in the said control system a representation of the Operator comprising: specification of the Operator, at least one predetermined, and/or dynamically updated, allowed range related, and/or co-related to release or emission of substances by the Operator; and
Producing a control signal by the said control system for use by a control apparatus when at least one measured value of representation of the operation of the Machine is outside the allowed range of corresponding value of representation of the Operator, said control apparatus being operable to transmit a warning signal, and/or interrupt, and/or modify the operation of the Machine.

2- The method of claim 1 further comprising transmitting the said control signal to the said control apparatus.

3- The method of claim 1 further comprising transmitting the said control signal to a remote location, and/or indicating that control signal is active.

4- The method of claim 1 wherein receiving representation of operation of the Machine further comprises receiving a remotely generated wave signal carrying the representation values.

5- The method of claim 1 wherein receiving representation of operation of the Machine, and/or representation of the Operator, comprises receiving a data from a wired or wireless communication system.

6- The method of claim 4 wherein receiving representation of operation, and/or representation of the Operator of the Machine, comprises extracting value data from an information chip, and/or from a dedicated network, and/or an Internet protocol.

7- The method of claim 1 wherein Machine is at least one type of: land, and/or sea, and/or air/space transportation means.

8- The method of claim 1 wherein Operator is: a human, and/or a robot, and/or a remotely controlled device.

9- The method of claim 4 wherein receiving: said representation of operation of the Machine, and/or said representation of the Operator, comprises plurality of values relating to one, or more than: one Machine, and/or one Operator.

10- The method of claim 1 wherein producing said control signal comprises comparing a value of said representation of the operation of the Machine with respective value of representation of the Operator and producing a control signal when at least one said value of representation of operation of the Machine is outside of the respective value of said representation of the Operator.

11- The method of claim 9 wherein producing said control signal comprises comparing a set of values of representation of the operation of the Machine with a corresponding set of values of representation of the Operator and producing said control signal when a set of values of representation of operation of the Machine is outside of the corresponding set of values in the allowed representation of the Operator.

12- The method of claim 1 further comprising:
a—updating the said representation of operation of the Machine, and/or representation of the Operator, in the storage device of the said computerized control system and/or the information chip; and
b—transmitting updated representation of operation of the Machine, and/or representation of the Operator to a remote location.

13- The method of claim 1 further comprising receiving in the said control system representation of the Operator from a remote entity.

14- The method of claim 1 further comprises displaying: said representation of the operation of the Machine, and/or said representation of the Operator; in a local or remote device.

15- The method of claimi wherein receiving representation of the Operator comprises receiving user input through a wired, and/or wireless interface device.

16- The method of claim 1 further comprises one or more measurement device to produce at least one measured value of representation of the operation of the Machine.

17- Providing a control apparatus aboard the Machine, and/or aboard the component or peripheral of the Machine; said control apparatus is responsive to said control signal in claims 1, 10, and 11. It has the capability to override the Operator's input, and may take one or all of the following actions:
a—restrict power to ignition, navigation, fuel supply, or starter system of the Machine if Machine is stationed;
b—reduce or adjust the fuel flow by regulating the fuel supply system, to make a safe and gradual stop if Machine is moving;
c—to inform and alarm the Operator of exceeding allowed quota range;
d—Smartly or by indication of the Operator or control system to adjust the flow of the fuel towards desirable level of emission or release of substances; and
e—Smartly adjust usage of peripheral equipments of the Machine towards least emission or release of substances.

18- A system for affecting the operation of a Machine by an Operator with respect to the range of Operator's allowed quota, the system comprising: A first database, configured to store first data relating to representation of operation of a Machine, as defined in claim 1 and submit it to the control system in the format of instruction codes executable by a programmable device; A second database, configured to store second data relating to the representation of an Operator, as defined in claim 1 and submit it to the control system in the format of instruction codes executable by a programmable device; and A programmable device, as part of the control system configured to process the first data, the second data, to determine if a control signal has to be produced and: transmitted to the control apparatus as defined in the claim 17, and/or to be transmitted in the format of instruction codes executable by a remote programmable device according to a network protocol, to a remote location.

19- System of claim 18 wherein first database and second database are different databases.

20- System of claim 18 wherein first database and second database are the same database.

21- System of claim 18 wherein first data, and/or second data, are transmitted to the said programmable device from the said control system.

22- System of claim 18 wherein first data, and/or second data are transmitted to, and extracted for the use of the said programmable device through a dedicated network, or an Internet protocol.
